(19) United States
(12) Patent Application Publication
(10) Pub. No.: US 2023/0204418 A1
(43) Pub. Date: Jun. 29, 2023

(54) HIGH-SPEED AND HIGH-PRECISION SPECTRAL VIDEO SYSTEM AND METHOD FOR FLAME SHOOTING

(71) Applicant: NANJING UNIVERSITY, Nanjing, Jiangsu (CN)

(72) Inventors: Xun CAO; Zhengyu LIU; Linsen CHEN; Lijing CAI; Yan ZHANG; Chen WANG

(21) Appl. No.: 17/754,882

(22) PCT Filed: Oct. 28, 2020
(86) PCT No.: PCT/CN2020/124191

§ 371 Date: Apr. 14, 2022

(30) Foreign Application Priority Data
Oct. 30, 2019 (CN) 201911044312.1

(51) Int. Cl. G01J 3/28; G01J 3/02; G06T 5/00; G06T 5/20

(52) U.S. Cl. CPC G01J 3/2823; G01J 3/0229; G06T 5/00; G06T 5/20; G06T 2207/10016; G06T 2207/10024; G06T 2207/20028; G06T 2207/20032

(57) ABSTRACT

A high-speed and high-accuracy spectral video system has a filter module that filters optical signals in desired bands; a beam splitting module that splits the signal from the filter module into two identical beams entering an encoding aperture module and an RGB information acquisition module, respectively; a dispersion module disperses the optical signal and transmits the dispersed signal to a grayscale information acquisition module; a data reconstruction module aligns the signal from the grayscale information acquisition module to the signal from the RGB information acquisition module, denoises the signals, reconstructs a video by a bilateral filtering algorithm, and sends the reconstructed video to a display module for storage and display. A flame spectrum can be reconstructed using few sampling points to obtain broad-band spectral characteristics of the flame or using many sampling points to obtain high-accuracy spectral data.

### TECHNICAL FIELD OF THE INVENTION

The present invention relates to the fields of computational photography and combustion diagnostics, in particular to a high-speed and high-accuracy spectral video system and method for flame shooting.

### BACKGROUND OF THE INVENTION

Conventional cameras, which mimic the human eye and use a Bayer filter to record measurements on a sensor, lack lot of detail spectral information. While hyperspectral imaging systems are dedicated to measuring tens or even hundreds of spectral samples for each pixel, the obtained hyperspectral images can be considered as a 3D data cube, where two dimensions constitute a plane space and the third dimension is the spectrum. The internal details of high-resolution spectral images can reveal the inherent properties of the subject being shot and ambient light. Such data have important applications in many fields, such as military affairs, agriculture, mineral exploration and identification, and criminal investigation.

In the field of combustion, flame monitoring has always been a research focus. The gas combustion in the process of fuel application is a complex physicochemical process in which the transfer of energy and heat couples the interaction between flow, heat and mass transfer and chemical reaction. Studying flame spectra can help to measure the combustion regime of flame, determine reaction products, reconstruct the temperature field and concentration field, etc.

In the spectral measurement of gas combustion flame, the flame is an unsteady process changing constantly in which the chemical reactions, temperature and products are constantly changing. However, traditional methods for measuring flame spectra by a single-point or scanning spectrometer cannot obtain dynamic spectral data with two-dimensional spatial resolution at the same time. Meanwhile, a spectral signal of flame can cover a broad band with narrow characteristic peaks, so the spectrometer is required to perform flame shooting in the broad band and also have high spectral resolution.

### SUMMARY OF THE INVENTION

In view of the above technical difficulties in combustion diagnostics, an objective of the present invention is to provide a spectral video system suitable for flame shooting, which can obtain spectral information with temporal, spectral and spatial resolutions at the same time, thus allowing flame shooting in a broad band and also obtaining high-resolution spectral data near characteristic peaks. Another objective of the present invention is to provide a measurement method using the above spectral video system.

A technical solution employed by the present invention is as follows.

A high-speed and high-accuracy spectral video system for flame shooting is provided, including a filter module, a beam splitting module, an encoding aperture module, a dispersion module, a grayscale information acquisition module, an RGB information acquisition module, a data reconstruction module and a display module, where the filter module filters light beams of the flame to obtain optical signals in desired bands; the beam splitting module splits the optical signals output from the filter module into two identical beams, with one beam entering the encoding aperture module and the other beam entering the RGB information acquisition module; the encoding aperture module sparsely samples and encodes the optical signals of the flame, and transmits the optical signals to the dispersion module; the dispersion module disperses the optical signals to obtain spectral information; the grayscale information acquisition module acquires the spectral information from the dispersion module and transmits the signals to the data reconstruction module; the RGB information acquisition module acquires an RGB video signal with high spatial resolution output from the beam splitting module and transmits the signal to the data reconstruction module; the data reconstruction module aligns the signal from the grayscale information acquisition module to the signal from the RGB information acquisition module, denoises the signals, reconstructs a video by a bilateral filtering algorithm, and sends the reconstructed video to the display module; and the display module stores and displays the reconstructed high-resolution spectral video.

Further, the filter module consists of a broad-band filter of 400-800 nm and eight narrow-band filters of 400-800 nm, the bandwidth of the eight narrow-band filters is 450 nm, 500 nm, 550 nm, 600 nm, 650 nm, and 700 nm, respectively, and the broad-band filter and the narrow-band filters are mounted in a circle on a wheel.

Further, the beam splitting module is a beam splitter.

Further, the encoding aperture module includes an objective lens that forms an image of the flame on the plane of a wheel mask, and the wheel mask that sparsely samples and encodes the optical signals of the flame, and the wheel mask includes a mask with few sampling points for broad band imaging and a mask with many sampling points for narrow band imaging.

Further, the dispersion module includes a relay lens that transforms the optical signal output from the encoding aperture module into directional light, and a grating that performs linear dispersion to obtain spectral information.

Further, the grayscale information acquisition module includes an eyepiece and a high-speed grayscale camera.

Further, the RGB information acquisition module includes an industrial lens and a high-speed RGB camera.

Further, the data reconstruction module denoises the signals from the grayscale information acquisition module: a dark background noise is removed by a captured dark background image, and salt-and-pepper noises are removed by median filtering.

According to the present invention, a measurement method includes following specific steps of: acquiring and processing broad-band spectral data of the flame by the broad-band filter of the filter module and the mask with few sampling points of the encoding aperture module, and then reconstructing spectral data by the data reconstruction module; in this case, there are few sampling points and the reconstruction accuracy is low; and finding out characteristic peaks representing different chemical reactions in a spectral curve, acquiring and processing narrow-band spectral data of the flame by the narrow-band filter corresponding to the bands with characteristic peaks in the filter module and the mask with many sampling points of the encoding aperture module, and reconstructing the high-accuracy spectral data again by the data reconstruction module.

To solve the problems encountered in flame monitoring, a spectral video system with temporal, spatial spectral resolutions is provided, which uses a grating as a dispersion element to achieve high spectral resolution of 1 nm and completes high-speed flame shooting at 200 fps using a scientific sCMOS high-speed camera design system.

There are some problems in the existing flame spectrum monitoring, such as a broad band of the entire flame spectrum and narrow bands with characteristic peaks, so a video spectrometer is required to have both broad spectral detection range and high spectral resolution and reconstruction accuracy. To solve this problem, the wheel filters and the wheel masks which are fitted to the system are designed in the present invention. In the measurement of data, the wheel filter and the mask are adjusted to the broad-band filter and the mask with few sampling points, and the broad-band spectral data of the flame are acquired and processed using few sampling points to obtain the broad-band spectral data of the flame; and after positions of the characteristic peaks are determined, the wheel filter and the mask are adjusted to the corresponding narrow-band filter and mask with many sampling points, and the spectral data in narrow bands near the characteristic peaks are measured using many sampling points to obtain the spectral data with high spectral accuracy near the characteristic peaks. The measurement method can detect the entire broad spectral domain of the flame, and also can find out the characteristic peaks and acquire and reconstruct high-accuracy spectral data in narrow spectral domains near the characteristic peaks of the flame.

### BRIEF DESCRIPTION OF THE DRAWINGS

FIG. 1 is a structural diagram of a spectral video system according to the present invention;

FIG. 2 is a structural diagram of an optical path of the spectral video system according to the present invention;

FIG. 3 is a flow chart of a broad-band and narrow-band spectral data acquisition method according to the present invention; and

FIG. 4 is a flowchart of a spectral video data acquisition and processing method according to the present invention.

### DETAILED DESCRIPTION OF THE INVENTION

A core idea of the present invention is to provide a spectral video camera system capable of obtaining temporal, spectral and spatial resolutions at the same time for flame monitoring, which can obtain spectral data of the flame both with low spectral accuracy in a broad band and high spectral accuracy in narrow bands near characteristic peaks. The system measures broad-band spectral data with low spectral accuracy of the flame using few sampling points, and then measures narrow-band spectral data with high spectral accuracy near the characteristic peaks using many sampling points after determining positions of the characteristic peaks. In the system, the gray channel sparsely samples optical signals by a mask and then disperses the signals by a grating, while RGB channels directly acquire video signals with high spatial resolution. Video frames acquired by two cameras are synchronously aligned and rectified to obtain RGB video frames, on which some uniformly spaced sparse pixels have both RGB pixels and multi-channel spectral response. The noise is removed by a denoising algorithm, and a video containing spectral information is reconstructed by a bilateral filtering algorithm, stored and displayed.

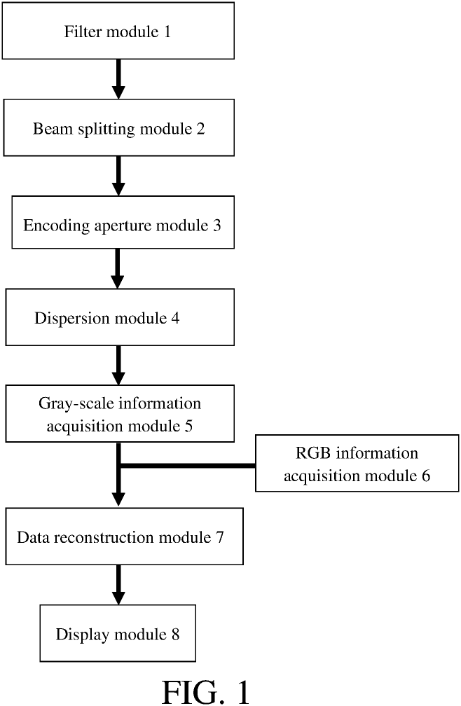

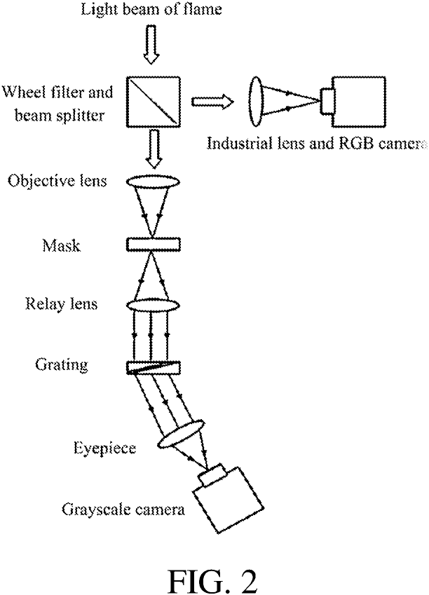

A high-speed and high-accuracy spectral video system for flame shooting as shown in FIG. 1 includes a filter module 1, a beam splitting module 2, an encoding aperture module 3, a dispersion module 4, a grayscale information acquisition module 5, an RGB information acquisition module 6, a data reconstruction module 7 and a display module 8. A specific structure of an optical path is shown in FIG. 2. Specifically, the filter module 1 consists of a filter wheel configured to filter out optical signals outside desired bands. The beam splitting module 2 consists of a beam splitter configured to split an optical signal output from the filter module into two identical beams, with one beam entering the encoding aperture module and the other beam entering the RGB information acquisition module. The encoding aperture module 3 includes an objective lens that forms an image of the flame on the plane of a wheel mask, and the wheel mask that sparsely samples and encodes the optical signal of the flame, where the wheel mask includes a mask with few sampling points for broad band imaging and a mask with many sampling points for narrow band imaging. The dispersion module 4, consisting of a relay lens and a grating, is configured to disperse the sparsely sampled optical signals to obtain spectral information, where the relay lens transforms the optical signal output from the encoding aperture module into directional light, and the grating performs linear dispersion to obtain spectral information. The optical signals output from the dispersion module enter the grayscale information acquisition module 5 consisting of an eyepiece and a high-speed grayscale camera, and converged by the eyepiece to form an image on a target plane of a sensor of a grayscale camera, and a captured video is stored in a host computer by a video capture card connected to the camera. The RGB information acquisition module 6, consisting of an industrial lens and a high-speed RGB camera, is configured to acquire RGB video signals with high spatial resolution output from the beam splitting module and transmit the signals to the data reconstruction module. The data reconstruction module 7 is configured to align and rectify a spectral video received from the grayscale information acquisition module 5 and an RGB video from the RGB information acquisition module 6, denoise the two videos and reconstruct a spectral video with high resolution, and send the reconstructed video to the display module 8. The display module 8 is configured to display the spectral video reconstructed by the data reconstruction module 7.

Preferably, in the embodiment of the present invention, the high-speed grayscale camera in the grayscale information acquisition module 5 is a pco.edge.4.2 scientific sCOMS high-speed camera from PCO, with a maximum resolution of 2048 × 2048 and a pixel size of 6.5 × 6.5 microns. Thehigh-speed RGB camera in the RGB information acquisition module 6 is a pco.edge.5.5 scientific sCOMS high-speed camera from PCO, with a maximum resolution of 2560x 2160 and a pixel size of 6.5× 6.5 microns. Both cameras can capture videos at 200 fps.

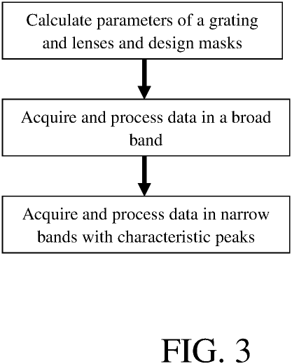

A main operation flow of the system shown in FIG. 3 can be described as follows.

Parameters of the grating and the lens are calculated and the mask is designed according to the requirements of monitoring band and spectral resolution provided by combustion diagnosis. Given a field angle of the beam in the desired band dispersed by the grating (which can be calculated from the selected parameters and formula of the grating) is a, the pixel size of the sensor is x, and the desired number of spectral channels is n, the focal length of the eyepiece is:

$$\text{F =} \text{nx} / \text{a}$$

In the design of the mask, it is crucial to determine the distance between two rows of slits of the mask:

$$\text{D = nrx}$$

where r represents a focal ratio of the relay lens to the eyepiece, and in this embodiment, r=2.

The above formula shows that if the spectrum to be measured has a broad band and the spectral resolution is still 1 nm, there will be more spectral channels, and the larger distance between two rows of slits of the mask allows fewer slits of the mask, resulting in few sampling points and low accuracy of the reconstructed spectral data. If the spectrum has narrow bands, there will be many sampling points, and the accuracy of the reconstructed spectral data will be high.

In the system, the broad bands ranges from 400 nm to 800 nm in width, and a total of eight narrow bands ranging from 400 nm to 800 nm in width are spaced every 50 nm. Therefore, the wheel filter consists of a broad-band filter of 400-800 nm and eight narrow-band filters of 400-800 nm spaced every 50 nm. The nine filters are mounted in a circle on the wheel, and the desired band filter is selected by rotating the wheel, so as to obtain the spectral data in the broad band or a specific narrow band. The focal length of the relay lens is 50 mm, and the focal length of the eyepiece is 25 mm. A mask with few sampling points for broad band imaging and a mask with many sampling points for narrow band imaging are designed with the broad bandwidth of 400 nm and the narrow bandwidth of 50 nm, respectively.

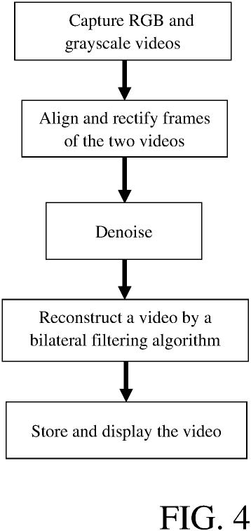

With the designed system, the wheel filter and the mask are adjusted to the broad-band filter and the mask with few sampling points, and the broad-band data of the flame are acquired and processed to reconstruct spectral data. In this case, there are few sampling points and the reconstruction accuracy is low. The characteristic peaks representing different chemical reactions are found out in a spectral curve, the wheel filter and the mask are adjusted to the vicinity of the band with corresponding characteristic peak and the mask with many sampling points, and the narrow-band data are acquired and processed to reconstruct the spectral data. In this case, there are many sampling points and the reconstruction accuracy is high. The broad-band or narrow-band spectral video data acquisition and processing method of the system is carried out according to the flowchart in FIG. 4. A specific flow in FIG. 4 is as follows.

Optical signals are acquired at front ends of two cameras, with signals outside the desired band being filtered out by the wheel filter, and the light beam of the flame is split into two identical beams by the beam splitter, where one beam is sparsely sampled by the mask and dispersed by the grating for spreading optical wave, and then acquired by the grayscale camera to obtain a grayscale video with high spectral resolution, while the other beam is directly acquired by the RGB camera to obtain an RGB video with high spatial resolution.

Frames of the two videos are aligned by corner alignment. The two cameras are configured to shoot four corners of a rectangle at the same time, so as to calculate a transition matrix through which and the sampling points of gray channel and the RGB channel are aligned.

The signals obtained by the gray channel are denoised. Some subjects being shot (e.g., premixed flames, which are semi-transparent and low in brightness) have weak optical signals, and the noise exerts a large impact, so the denoising is required. After the flame information is acquired, an all-black image is captured in a darkroom (the system parameters are exactly the same as before) as the dark background noise. The dark background noise is removed from frames of the original video, and random salt-and-pepper noises are removed by median filtering.

After the denoised video is obtained, the dimension of spectral information of pixels is reduced by Principal Component Analysis (PCA) to simplify calculations, and high-resolution spectral information of all pixels at the wavelength of 400-450 nm is obtained by a spectral propagation algorithm of bilateral filtering, and then is inversely transformed by PCA.

Finally, the reconstructed data are stored and displayed on the host computer.

1. A high-speed and high-accuracy spectral video system for flame shooting, comprising a filter module, a beam splitting module, an encoding aperture module, a dispersion module, a grayscale information acquisition module, an RGB information acquisition module, a data reconstruction module and a display module, wherein the filter module filters light beams of the flame to obtain optical signals in desired bands; the beam splitting module splits the optical signal output from the filter module into two identical beams, with one beam entering the encoding aperture module and the other beam entering the RGB information acquisition module; the encoding aperture module sparsely samples and encodes the optical signals of the flame, and transmits the optical signals to the dispersion module; the dispersion module disperses the optical signals to obtain spectral information; the grayscale information acquisition module acquires the spectral information from the dispersion module and transmits the signals to the data reconstruction module; the RGB information acquisition module acquires an RGB video signal with high spatial resolution output from the beam splitting module and transmits the signal to the data reconstruction module; the data reconstruction module aligns the signal from the grayscale information acquisition module and the RGB information acquisition module, denoises and reconstructs a video by a bilateral filtering algorithm, and sends the reconstructed video to the display module; and the display module stores and displays the reconstructed high-resolution spectral video.

2. The high-speed and high-accuracy spectral video system for flame shooting according to claim 1, wherein the filter module consists of a broad-band filter of 400-800 nm and eight narrow-band filters of 400-800 nm, the bandwidth of the eight narrow-band filters is 450 nm, 500 nm, 550 nm, 600 nm, 650 nm and 700 nm, respectively, and the broad-band filter and the narrow-band filters are mounted in a circle on a wheel.

3. The high-speed and high-accuracy spectral video system for flame shooting according to claim 1, wherein the beam splitting module is a beam splitter.

4. The high-speed and high-accuracy spectral video system for flame shooting according to claim 1, wherein the encoding aperture module comprises an objective lens that forms an image of the flame on the plane of a wheel mask, and the wheel mask that sparsely samples and encodes the optical signals of the flame, and the wheel mask comprises a mask with few sampling points for broad band imaging and a mask with many sampling points for narrow band imaging.

5. The high-speed and high-accuracy spectral video system for flame shooting according to claim 1, wherein the dispersion module comprises a relay lens that transforms the optical signal output from the encoding aperture module into directional light, and a grating that performs linear dispersion to obtain spectral information.

6. The high-speed and high-accuracy spectral video system for flame shooting according to claim 1, wherein the grayscale information acquisition module comprises an eyepiece and a high-speed grayscale camera.

7. The high-speed and high-accuracy spectral video system for flame shooting according to claim 1, wherein the RGB information acquisition module comprises an industrial lens and a high-speed RGB camera.

8. The high-speed and high-accuracy spectral video system for flame shooting according to claim 1, wherein the data reconstruction module denoises the signals from the grayscale information acquisition module: a dark background noise is removed by a captured dark background image, and salt-and-pepper noises are removed by median filtering.

9. A measurement method using the high-speed and high-accuracy spectral video system for flame shooting according to claim 1, comprising following specific steps of:
acquiring and processing broad-band spectral data of the flame by the broad-band filter of the filter module and the mask with few sampling points of the encoding aperture module, and then reconstructing spectral data by the data reconstruction module; in this case, there are few sampling points and the reconstruction accuracy is low; and
finding out characteristic peaks representing different chemical reactions in a spectral curve, acquiring and processing narrow-band spectral data of the flame by the narrow-band filter corresponding to the bands with characteristic peaks of the filter module and the mask with many sampling points of the encoding aperture module, and reconstructing the high-accuracy spectral data again by the data reconstruction module.
